(19) United States
(12) Patent Application Publication
(10) Pub. No.: US 2008/0214079 A1
(43) Pub. Date: Sep. 4, 2008

(54) Double-Coated Pressure-Sensitive Adhesive Tape

(75) Inventors: Satoshi Harai, Tokyo (JP); Rina Mawatari, Kanagawa-ken (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/911,608

(22) PCT Filed: Apr. 13, 2006
(86) PCT No.: PCT/US06/14171

§ 371 Date: Oct. 15, 2007

(30) Foreign Application Priority Data
Apr. 15, 2005 (JP) 2005-118244

(51) Int. Cl. C09J 7/04; B32B 37/04; B32B 37/12

(52) U.S. Cl. 442/151; 156/155

(57) ABSTRACT

A double-coated pressure-sensitive adhesive tape comprising a core material composed of a nonwoven fabric with a thickness of no greater than 20 μm, and a pressure-sensitive adhesive layer comprising an acrylic-based polymer with a glass transition temperature (Tg) of between −20° C. and 20° C. and with a weight-average molecular weight of 1 million or greater, on both sides of the core material, the double-coated pressure-sensitive adhesive tape having a total thickness of no greater than 60 μm.

### Field

The present invention relates to a highly heat-resistant acrylic-based pressure-sensitive adhesive tape, and more specifically it relates to a double-coated pressure-sensitive adhesive tape that can be used under the high-temperature conditions of solder reflow steps and the like carried out during the manufacture of electronic devices.

### BACKGROUND

As double-coated pressure-sensitive adhesive tapes, there are conventionally known resin-based films or foams made of polyester, polyethylene and the like, or paper and fabric films such as high-quality paper, coated paper and nonwoven fabrics, used as base materials which are coated on both sides with a pressure-sensitive adhesive. Pressure-sensitive adhesive tapes are used for a variety of purposes, including anchoring of construction materials and anchoring of electronic device parts. When used in solder reflow steps which involve heating at 240° C. and higher, and especially about 260° C., resin films such as polyethylene and polyester resin films undergo heat shrinkage which alters their dimensions. Heat-resistant films made of polyimide and the like cannot yield double-coated pressure-sensitive adhesive tapes in an economical manner.

When the base material used is a common high-quality paper, coated paper or a nonwoven fabric with a basis weight of 10 g/m² or greater, the thickness of the base material itself usually exceeds about 30 μm, rendering it difficult to reduce the thickness of the double-coated pressure-sensitive adhesive tape and obtain a double-coated pressure-sensitive adhesive tape that maintains adequate adhesive force. For attachment of electronic parts in particular, it is desirable to achieve double-coated pressure-sensitive adhesive tape with a very low thickness such as 60 μm or smaller, but it has not yet been possible to achieve adequate adhesive force using such base materials.

On the other hand, double-coated pressure-sensitive adhesive tapes that lack a base material can provide sufficient adhesive force, but suffer blocking or paste bleeding onto the adherend, while their workable properties are often problematic during punching when they are attached to adherends.

Japanese Unexamined Patent Publication No. 2004-196867 discloses a pressure-sensitive adhesive composition for a solder reflow step. The disclosed pressure-sensitive adhesive composition is described as having heat resistance allowing it to withstand the reflow step. Japanese Unexamined Patent Publication No. 2004-196867 also mentions that the disclosed pressure-sensitive adhesive composition can be used to produce a double-coated pressure-sensitive adhesive tape without a base, and that double-coated pressure-sensitive adhesive tapes may also be produced using various base materials. However, while the pressure-sensitive adhesive composition is examined in the working examples, the properties of a double-coated pressure-sensitive adhesive tape also employing a base material are not discussed.

Japanese Unexamined Patent Publication No. 2004-018664 discloses a pressure-sensitive adhesive tape comprising a butyral resin as the core material. It is stated that the pressure-sensitive adhesive composition may employ publicly known substances such as acrylic-based resins, urethane-based resins, silicone-based resins and natural or synthetic rubbers without any restrictions. Thus, Japanese Unexamined Patent Publication No. 2004-018664 does not discuss use at high temperature, and especially does not consider use of the tape at high temperatures of 240° C. and above.

### SUMMARY OF THE INVENTION

It is a desire of the present invention to provide a double-coated pressure-sensitive adhesive tape which has a total tape thickness of no greater than 60 μm, which has satisfactory working properties including a property of punching and does not cause blocking or paste bleeding problem, and which can maintain excellent pressure-sensitive adhesive force and cohesive force even when subjected to high temperatures.

According to one mode, the present invention provides a double-coated pressure-sensitive adhesive tape comprising a core material composed of a nonwoven fabric with a thickness of no greater than 20 μm, and a pressure-sensitive adhesive layer comprising an acrylic-based polymer with a glass transition temperature (Tg) of between −20° C. and 20° C. and with a weight-average molecular weight of 1 million or greater, on both sides of the core material, the double-coated pressure-sensitive adhesive tape having a total thickness of no greater than 60 μm.

The “glass transition temperature (Tg)” is the temperature at which the maximum loss tangent (tan δ) is exhibited when using a viscoelasticity measuring apparatus in shear mode with 2% shear strain and 1.0 Hz frequency, in a temperature range of −80° C. to 300° C. at a temperature-elevating rate of 5° C./min.

The “weight-average molecular weight” is the weight-average molecular weight, measured by gel permeation chromatography (GPC) using polystyrene standard.

### DETAILED DESCRIPTION

Since the double-coated pressure-sensitive adhesive tape according to the invention employs a specific nonwoven fabric as described above, it has satisfactory working properties including a property of punching and does not cause blocking or paste bleeding problem, even when the overall tape thickness is 60 μm or smaller. Moreover, the double-coated pressure-sensitive adhesive tape of the invention can maintain excellent pressure-sensitive adhesive force and cohesive force even when subjected to high temperatures.

The double-coated pressure-sensitive adhesive tape of the invention will now be explained based on preferred embodiments. However, it is to be understood that the invention is in no way limited by these concrete embodiments.

The double-coated pressure-sensitive adhesive tape of the invention is heat-resistant pressure-sensitive adhesive tape suitable for adhesion of electronic device parts. Thus, the pressure-sensitive adhesive layer on both sides of the core material of the double-coated pressure-sensitive adhesive tape must also be heat-resistant. The pressure-sensitive adhesive layer is preferably one which can maintain its pressure-sensitive adhesive force and cohesive force even under temperatures of 240° C. and higher, and especially around 260° C., in solder reflow steps. The pressure-sensitive adhesive layer used for the invention comprises an acrylic-based polymer with a glass transition temperature (Tg) of between −20° C. and 20° C. and with a weight-average molecular weight of 1 million or greater, and the acrylic-based polymer having such properties is capable of exhibiting the aforementioned high heat resistance.

### Pressure-Sensitive Adhesive Layer

An acrylic-based polymer used in the pressure-sensitive adhesive layer is, more specifically, an acrylic-based polymer obtained by copolymerization of a mixture containing the following monomers (a) and (b).

(a) 0.01-20 wt % of a monomer with a radical polymerizable unsaturated group and at least one reactive functional group, and

(b) 80-99.99 wt % of a (meth)acrylic acid ester-based monomer other than (a).

As examples of the monomer (a) having a radical polymerizable unsaturated group and at least one reactive functional group there may be mentioned monomers containing carboxyl groups such as (meth)acrylic acid, β-carboxyethyl acrylate, itaconic acid, crotonic acid, fumaric acid, fumaric anhydride, maleic acid, maleic anhydride and butyl maleate, or monomers containing hydroxyl groups such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylhexyl)-methyl acrylate, chloro-2-hydroxypropyl (meth)acrylate, diethyleneglycol mono(meth)acrylate, caprolactone-modified (meth)acrylates, polyethyleneglycol (meth)acrylates and polypropyleneglycol (meth)acrylates. There may also be mentioned monomers containing amino groups such as aminomethyl (meth)acrylate, monomers containing amide groups such as acrylamide, monomers containing maleimide groups such as N-cyclohexylmaleimide, monomers containing itaconimide groups such as N-methylitaconimide, or monomers containing succinimide groups such as N-(meth)acryloyloxymethylenesuccinimide, and monomers containing epoxy groups such as glycidyl (meth)acrylate. These may be used alone or in combinations of two or more. The amount of use is 0.01-20 wt % based on the total monomer weight, because if the amount is less than 0.01 wt % the cohesive force of the pressure-sensitive adhesive layer is reduced and foaming or peeling may occur in heated environments, while if it is greater than 20 wt % the pressure-sensitive adhesive force tends to be reduced.

As examples of the (meth)acrylic acid ester monomer (b) other than (a) there may be mentioned methyl (meth)acrylate, ethyl (meth)acrylate, propyl (meth)acrylate, n-butyl (meth)acrylate, isobutyl (meth)acrylate, 2-ethylhexyl (meth)acrylate, n-octyl (meth)acrylate, isooctyl (meth)acrylate, lauryl (meth)acrylate, stearyl (meth)acrylate, isononyl (meth)acrylate, cyclohexyl (meth)acrylate, benzyl (meth)acrylate, methoxyethyl (meth)acrylate, ethoxyethyl (meth)acrylate and phenoxyethyl (meth)acrylate. The amount of use is 80-99.99 wt % based on the total monomer weight, and the compounds mentioned for monomer (b) may be used alone or in combinations of two or more.

As appropriate, there may also be used a monomer (c) in addition to the monomers (a) and (b), which is copolymerizable with the monomers (a) and (b). As examples of the monomer (c) there may be mentioned vinyl acetate, styrene, methylstyrene, vinyltoluene and acrylonitrile. The amount of use is normally 0-20 wt % based on the total monomer weight.

The pressure-sensitive adhesive layer of the invention must contain an acrylic-based polymer with a glass transition temperature (Tg) of between −20° C. and 20° C. and with a weight-average molecular weight of 1 million or greater.

If the glass transition temperature (Tg) is between −20° C. and 20° C., the pressure-sensitive adhesive of the invention will be capable of exhibiting high adhesion and suitable cohesion and heat resistance. If it is below −20° C. the pressure-sensitive layer will be soft and fail to exhibit retentive strength and heat resistance because of low cohesive force, despite satisfactory pressure-sensitive adhesion. If it is above 20° C., the pressure-sensitive adhesive layer will be hard, with increased cohesive force and heat resistance, but without sufficient pressure-sensitive adhesive force.

The acrylic-based polymer must have a weight-average molecular weight of 1 million or greater. If the weight-average molecular weight is smaller than 1 million, the cohesive force will tend to be insufficient resulting in foaming or peeling, even when a crosslinking agent is used. If the weight-average molecular weight is greater than 2.5 million, however, the viscosity of the pressure-sensitive adhesive will be increased resulting in inferior workability for coating and the like. The preferred range for the weight-average molecular weight is 1-2 million.

The pressure-sensitive adhesive layer of the invention may also contain a tackifying resin depending on the case, for the purpose of modifying the pressure-sensitive adhesive property. As tackifying resins to be included there may be mentioned rosin-based tackifying resins, terpene-based tackifying resins, petroleum-based tackifying resins, coal-based tackifying resins and other tackifying resins. These tackifying resins may be used alone or in combinations of two or more.

The content of a tackifying resin in the pressure-sensitive adhesive layer of the invention is usually in the range of 0.5-100 parts by weight and preferably 1-50 parts by weight to 100 parts by weight of the acrylic-based polymer. Using a tackifying resin in this amount will result in excellent pressure-sensitive adhesive force.

The pressure-sensitive adhesive layer of the invention may contain a polyfunctional compound as a crosslinking agent. The functional groups in the polyfunctional compound are ones which react with the reactive functional group in the monomer (a), which has at least one functional group in addition to the radical polymerizable unsaturated group, and the polyfunctional compound is a molecule containing at least two functional groups, and preferably 2-4 functional groups. As examples of such polyfunctional compounds there may be mentioned isocyanate-based compounds, epoxy-based compounds, amine-based compounds, metal chelate-based compounds and aziridine-based compounds.

When the acrylic-based copolymer contains a carboxyl group, the heat resistance can be notably improved by using an epoxy-based compound among the aforementioned crosslinking agents.

These crosslinking agents are usually used in a range of 0.05-10 parts by weight to 100 parts by weight of the acrylic-based polymer. Using of a crosslinking agent in such an amount will form suitable three-dimensional crosslinks between the acrylic-based polymers, so that excellent heat resistance may be imparted to the polymers. The crosslinking agents may be used alone or in combinations of two or more.

Any publicly known method may be employed for production of an acrylic-based polymer to be included in a pressure-sensitive adhesive layer used for the invention. For example, the acrylic-based copolymer may be synthesized by a method of bulk polymerization, solution polymerization, emulsion polymerization or suspension polymerization using 0.001-5 parts by weight of a polymerization initiator with respect to 100 parts by weight of the starting monomers. The synthesis is preferably carried out by solution polymerization.

The pressure-sensitive adhesive layer of the invention may also contain, in addition to the components mentioned above, silane coupling agents, weather stabilizers, plasticizers, softeners, dyes, pigments, inorganic fillers and the like which are ordinarily included in pressure-sensitive adhesives.

### Nonwoven Fabric

The double-coated pressure-sensitive adhesive tape of the invention employs a nonwoven fabric with a thickness of no greater than 20 μm as the core material. A nonwoven fabric having such a thickness can guarantee a pressure-sensitive adhesive layer of sufficient thickness for obtaining a double-coated pressure-sensitive adhesive tape with adhesive force even if the total thickness of the double-coated pressure-sensitive adhesive tape is 60 μm or smaller. The nonwoven fabric is formed from a heat-resistant fiber material, for example, heat-resistant natural fibers such as cellulose-based pulp made of cotton or hemp, or rayon, or heat-resistant synthetic fibers such as polyamide fibers, or glass fibers. Fiber materials based on polyolefin- or polyester-based resins have a low melting point and are poorly suitable in terms of heat resistance. The nonwoven fabric may be one produced by a wet system or dry system, but a wet-system nonwoven fabric is preferred because it can have a smaller thickness given the same basis weight. The basis weight of the nonwoven fabric will differ depending on the type and density of the fibers used to form the nonwoven fabric, but is generally no greater than 10 g/m² for achieving the thickness described above.

The nonwoven fabric should also have good handling for tape production, and sufficient strength allowing it to withstand processings carried out after attachment. The nonwoven fabric preferably has a tensile strength of at least 1 N/15 mm (pull speed: 300 mm/min).

### Production of Double-Coated Pressure-Sensitive Adhesive Tape

Double-coated pressure-sensitive adhesive tape according to the invention may be produced in the following manner, for example.

A polymerizing mixture comprising the monomers for the acrylic-based polymer, and an azo compound-based or peroxide-based polymerization initiator, and the like is dissolved in an appropriate solvent such as ethyl acetate, toluene or methyl ethyl ketone to prepare a solution for polymerization, and polymerize it into an acrylic-based polymer with the prescribed molecular weight. Next, after addition of additives such as a tackifying agent or filler as necessary to the acrylic-based polymer, a crosslinking agent is added to obtain a pressure-sensitive adhesive composition. The obtained pressure-sensitive adhesive composition is applied and dried onto two releasable separators by die coating, knife coating, bar coating or any other commonly well-known application method, and the respective pressure-sensitive adhesive layers are heat laminated onto both sides of a nonwoven fabric to obtain a double-coated pressure-sensitive adhesive tape according to the invention.

### Use of Double-Coated Pressure-Sensitive Adhesive Tape

Double-coated pressure-sensitive adhesive tape according to the invention is preferably used for adhesion of a flexible circuit board onto another adherend. The pressure-sensitive adhesive tape of the invention has excellent working properties including punching properties, as well as heat resistance allowing it to withstand the process of solder reflow steps, and therefore one side of the double-coated pressure-sensitive adhesive tape of the invention can be attached to the back side of a flexible circuit board prior to the working step. Next, solder is situated on the circuit board, which is then subjected to a solder reflow step at 240° C. or higher, and particularly 260° C. or higher, and finally the back side of the flexible circuit board may be attached to a separate adherend via the double-coated pressure-sensitive adhesive tape of the invention. As separate adherends for attachment there may be used separate circuit boards such as glass epoxy boards or polyimide boards, or electronic device casings. An electronic device casing may be made of stainless steel, aluminum, magnesium or an alloy thereof.

### EXAMPLES

### Example 1

A 2-ethylhexyl acrylate/acrylic acid (90/10 by weight) monomer and 0.01 part by weight of azobisisobutyronitrile with respect to 100 parts by weight of the monomer were dissolved in ethyl acetate to obtain a solution. The solution was polymerized for 8 hours at reflux temperature to obtain a pressure-sensitive adhesive solution of an acrylic-based polymer with a weight-average molecular weight of 1.30 million (solid portion: 26%). One part by weight of the epoxy-based crosslinking agent E-AX (product of Soken Chemical and Engineering Co., Ltd.) was added to the pressure-sensitive adhesive solution. The resulting pressure-sensitive adhesive solution was applied and dried on two silicone-treated paper separators (#1732 by Kaito Chemical Co., Ltd., 85 μm thickness) to a post-drying pressure-sensitive adhesive coverage of 27 g/m², to obtain two pressure-sensitive adhesive layers. The 25 μm-thick pressure-sensitive adhesive layers on separators were situated on either side of a nonwoven fabric with a basis weight of 6 g/m² (wet-made nonwoven fabric composed of a pulp/rayon mixture, 18 μm thickness, tensile strength of 3 N/15 mm in machine direction (MD) (pull speed: 300 mm/min)), and heat laminated at 90° C. using a nip roll under an air pressure of 2.9×10⁵ Pa, to obtain a double-coated pressure-sensitive tape according to the invention. The details of the double-coated pressure-sensitive adhesive tape are shown in Table 1 below.

### Comparative Example 1

A double-coated pressure-sensitive adhesive tape was obtained in the same manner as Example 1, except that the nonwoven fabric used had a basis weight of 14 g/m² (wet-made hemp nonwoven fabric, 45 μm thickness, tensile strength in MD direction: 15 N/15 mm (pull speed: 300 mm/min)). The details of the double-coated pressure-sensitive adhesive tape are shown in Table 1 below.

### Comparative Example 2

A double-coated pressure-sensitive adhesive tape was obtained in the same manner as Example 1, except that the nonwoven fabric used had a basis weight of 14 g/m² (wet-made hemp nonwoven fabric, 45 μm thickness, tensile strength in MD direction: 15 N/15 mm (pull speed: 300 mm/min)), and the pressure-sensitive adhesive coverage on each side was 15 g/m². The details of the double-coated pressure-sensitive adhesive tape are shown in Table 1 below.

### Comparative Example 3

A double-coated pressure-sensitive adhesive tape was obtained in the same manner as Example 1, except that a double-side corona-treated, 12 μm-thick polyester film (S-12, product of Unitica Co., Ltd.) was used instead of the nonwoven fabric as the core material, and the pressure-sensitive adhesive coverage on each side was 20 g/m². The details of the double-coated pressure-sensitive adhesive tape are shown in Table 1 below.

### Comparative Example 4

A double-coated pressure-sensitive adhesive tape with no core material was obtained by applying and drying the pressure-sensitive adhesive solution produced in Example 1 on a silicone-treated paper separator (#1732 by Kaito Chemical Co., Ltd., 85 μm thickness) to a post-drying thickness of 50 μm. The details of the double-coated pressure-sensitive adhesive tape are shown in Table 1 below.

### Comparative Example 5

A double-coated pressure-sensitive adhesive tape was obtained in the same manner as Example 1, except that the acrylic-based polymer was one with a weight-average molecular weight of 1 million and a Tg of −40° C., obtained using an isooctyl acrylate/acrylic acid (90/10 by weight) monomer. The details of the double-coated pressure-sensitive adhesive tape are shown in Table 1 below.

### Comparative Example 6

A double-coated pressure-sensitive adhesive tape was obtained in the same manner as Example 1, except that the acrylic-based polymer was one with a weight-average molecular weight of 800,000 and a Tg of −5° C., obtained using an butyl acrylate/acrylic acid (90/10 by weight) monomer. The details of the double-coated pressure-sensitive adhesive tape are shown in Table 1 below.

The Tg and molecular weight of each pressure-sensitive adhesive layer in the examples and comparative examples were measured in the following manner.

1. Glass Transition Temperature (Tg) Measurement

The loss tangent (tan δ) was measured using an ARES viscoelasticity measuring apparatus by Rheometric Scientific, in shear mode with 2% shear strain and 1.0 Hz frequency, in a temperature range of −80° C. to 300° C. at a temperature-elevating rate of 5° C./min, and the temperature yielding the maximum tan δ was recorded as Tg.

2. Weight-Average Molecular Weight Measurement

This was the weight-average molecular weight measured by gel permeation chromatography (GPC), based on polystyrene standard. The GPC measurement was carried out with an HP1090 SERIES II by Agilent Co., with tetrahydrofuran as the solvent, a flow rate of 0.5 ml/min, and a sample concentration of 0.1 wt %.

3. Nonwoven Fabric Thickness Measurement

The nonwoven fabric used in the examples and Comparative Examples 1 and 2 was humidified under conditions of 23±2° C., 50±5 RH % (relative humidity) for 4 hours, and then the thickness was measured with a thickness meter according to JIS B 7503.

4. Total Tape Thickness Measurement

The total tape thickness was measured with a thickness meter according to JIS B 7503.

TABLE 1

| | Pressure-sensitive | | | | | |
|---|---|---|---|---|---|---|
| | adhesive | | | | Pressure- | |
| | Weight- | | | | sensitive | |
| | average | | Core material | | adhesive | Total tape |
| | molecular | Tg | | Thickness | coverage | thickness |
| | weight | (° C) | Material | (μm) | (g/m²) | (μm) |
| Example | 1,300,000 | 0 | Non-woven | 18 | 27/27 | 50 |
| | | | fabric with 6 | | | |
| | | | g/m² basis weight | | | |
| Comp. Ex. 1 | 1,300,000 | 0 | Non-woven | 45 | 27/27 | 70 |
| | | | fabric with 14 | | | |
| | | | g/m² basis weight | | | |
| Comp. Ex. 2 | 1,300,000 | 0 | Non-woven | 45 | 15/15 | 50 |
| | | | fabric with 14 | | | |
| | | | g/m² basis weight | | | |
| Comp. Ex. 3 | 1,300,000 | 0 | 12 μm PET film | 12 | 20/20 | 50 |
| Comp. Ex. 4 | 1,300,000 | 0 | none | — | 54 | 50 |
| Comp. Ex. 5 | 1,000,000 | −40 | none | — | 54 | 50 |
| Comp. Ex. 6 | 800,000 | −5 | none | — | 54 | 50 |

5. Evaluation Tests

5.1. Impregnation of Pressure-Sensitive Adhesive into Nonwoven Fabric

The double-coated tape of each of the examples and comparative examples cut to dimensions of 25 mm×25 mm was attached onto an anodized aluminum sheet and peeled off at a peel speed of 300 mm/min and a peel angle of 90°, for interlayer destruction of the pressure-sensitive adhesive layer including the nonwoven fabric. The destroyed surface of the destroyed nonwoven fabric was visually observed, and the condition of impregnation of the pressure-sensitive adhesive in the nonwoven fabric was judged. The symbol “OK” was assigned for impregnation of the pressure-sensitive adhesive, and “NG” was assigned for no impregnation. The results are shown in Table 2 below.

5.2. Punching Property

Each 500 mm-width double-coated pressure-sensitive adhesive tape obtained in the examples and comparative examples, having both sides covered with silicone-treated paper separators (#1732 by Kaito Chemical Co., Ltd., 85 μm thickness), had the silicone-treated paper separator peeled on one side to expose the pressure-sensitive adhesive surface, and a paper liner serving as a mount was attached onto the pressure-sensitive adhesive side. Next, a punching machine (Fuji Shoko Co., Ltd.) was used for die cutting from the side bearing the silicone-treated paper separator, followed by kiss cutting to fabricate a 20 mm×50 mm working sample. This was subjected to 1000 shots and visually examined for blocking or paste bleeding. The symbol “OK” was assigned for absence of blocking or paste bleeding, and “NG” was assigned for their presence. The results are shown in Table 2 below.

Measurement was conducted before and after the conditions of the solder reflow step in the dimensional change test of 5.3. below, and after the conditions of the solder reflow step in the adhesive force test of 5.4. below. The double-coated pressure-sensitive adhesive tape was attached to the polyimide side of a 75 μm copper/polyimide laminated film (Nippon Graphite Industries, Ltd., CCL, laminated film of circuit board copper and polyimide), and passed through a reflow oven at 260° C. for 40 seconds. The side of the doubled-coated pressure-sensitive adhesive tape not in contact with the polyimide was attached to a silicone-treated paper separator (#1732 by Kaito Chemical Co., Ltd., 85 μm thickness).

5.3. Dimensional Change

The dimensional change in a 10 cm×10 cm double-coated pressure-sensitive adhesive tape before and after the conditions of the reflow step was measured using a digital caliper.

The measurement was of the dimension from the center of one side of the square double-coated pressure-sensitive adhesive tape to the center of the counter side, and the dimension from the center of one side in the direction perpendicular to the previous side to the center of the counter side. The value for each side with the larger dimensional change before and after the reflow step is shown in Table 2.

5.4. Adhesive Force

A double-coated pressure-sensitive adhesive tape sample cut to a 25 mm width was attached to a glass epoxy board using a 2 kg-weight rubber roller, by a single roll pass at 300 mm/min. It was then subjected to the aforementioned conditions of the reflow step, and the adhesive force on the glass epoxy board was measured according to the method prescribed by JIS Z0237, with a peel speed of 300 mm/min and a peel angle of 180°. The results are shown in Table 2 below.

TABLE 2

| | Impregnation of | | | |
|---|---|---|---|---|
| | pressure- | | | |
| | sensitive | | Properties after reflow | |
| | adhesive into | | | Adhesive |
| | nonwoven | Punching | Dimensional | force |
| | fabric | property | change | (N/25 mm) |
| Example | OK | OK | none | 14 |
| Comp. | NG | OK | none | 14 |
| Ex. 1 | | | | |
| Comp. | NG | OK | none | 10 |
| Ex. 2 | | | | |
| Comp. | — | OK | 8% shrinkage | 10 |
| Ex. 3 | | | | |
| Comp. | — | NG | none | 15 |
| Ex. 4 | | | | |
| Comp. | — | NG | N.D.* | N.D.* |
| Ex. 5 | | | | |
| Comp. | — | NG | none | 12 |
| Ex. 6 | | | | |

*No data due to heat-induced deterioration of pressure-sensitive adhesion

What is claimed is:

1-3. (canceled)

4. A double-coated pressure-sensitive adhesive tape comprising:
a core having a thickness of no greater than 20 μm, wherein the core comprises a nonwoven fabric and
a pressure-sensitive adhesive layer on both sides of said core material, wherein the pressure sensitive adhesive comprises an acrylic-based polymer having a glass transition temperature (Ig) of between −20° C. and 20° C. and a weight-average molecular weight of 1 million or greater;
wherein said double-coated pressure-sensitive adhesive tape has a total thickness of no greater than 60 μm.

5. The double-coated pressure-sensitive adhesive tape according to claim 4, wherein the acrylic-based polymer comprises the copolymerization product of
(a) 0.01 to 20% by weight of on or more monomers with a radical polymerizable unsaturated group and at least one reactive functional group, and
(b) 80 to 99.99% by weight of one or more (meth)acrylic acid ester-based monomer other than monomer (a).

6. The double-coated pressure-sensitive adhesive tape according to claim 5, wherein the acrylic-based polymer comprises the copolymerization product of monomer (a), monomer (b), and up to 20% by weight of (c) a monomer selected from the group consisting of vinyl acetate, styrene, methylstyrene, vinyl toluene, and acrylonitrile.

7. The double-coated pressure-sensitive adhesive tape according to claim 4, wherein the acrylic-based polymer has a weight-average molecular weight of no greater than 2.5 million.

8. The double-coated pressure-sensitive adhesive tape according to claim 4, wherein the pressure-sensitive adhesive further comprises 1 to 50 parts by weight of tackifier per 100 parts by weight of the acrylic-based polymer.

9. The double-coated pressure-sensitive adhesive tape according to claim 4, wherein the pressure-sensitive adhesive further comprises a crosslinking agent, wherein the crosslinking agent is a polyfunctional compound having functional groups that react with the reactive functional group of monomer (a).

10. The double-coated pressure-sensitive adhesive tape according to claim 9, wherein the acrylic-based copolymer comprises a carboxyl group and the crosslinking agent is an epoxy-based compound.

11. The double-coated pressure-sensitive adhesive tape according to claim 4, wherein the non-woven fabric comprises natural fibers selected from the group consisting of cotton, hemp, or rayon.

12. The double-coated pressure-sensitive adhesive tape according to claim 4, wherein the non-woven fabric comprises synthetic fibers selected from the group consisting of polyimide and glass.

13. The double-coated pressure-sensitive adhesive tape according to claim 4, wherein the non-woven fabric has a basis weight of no greater than 10 grams per square meter.

14. The double-coated pressure-sensitive adhesive tape according to claim 4, wherein the non-woven fabric has a tensile strength of at least 1 Newton per 15 millimeters when measured at 300 millimeters per minute.

15. A method of attaching a flexible circuit board to an adherend comprising attaching a double-coated pressure sensitive adhesive tape to a backside or the flexible circuit board, subjecting the flexible circuit board to a solder reflow step at a temperature of at least 240° C., and attaching the backside of the circuit board to the adherend via the double-coated pressure sensitive adhesive tape, wherein the double-coated pressure-sensitive adhesive tape comprises:
a core having a thickness of no greater than 20 μm, wherein the core comprises a nonwoven fabric and
a pressure-sensitive adhesive layer on both sides of said core material,
wherein the pressure sensitive adhesive comprises an acrylic-based polymer having a glass transition temperature (Tg) of between −20° C. and 20° C. and a weight-average molecular weight of 1 million or greater;
wherein said double-coated pressure-sensitive adhesive tape has a total thickness of no greater than 60 μm.

16. The method according to claim 15, wherein the acrylic-based polymer comprises the copolymerization product of
(a) 0.01 to 20% by weight of on or more monomers with a radical polymerizable unsaturated group and at least one reactive functional group, and
(b) 80 to 99.99% by weight of one or more (meth)acrylic acid ester-based monomer other than monomer (a).

17. The method according to claim 16, wherein the pressure-sensitive adhesive further comprises a crosslinking agent, wherein the crosslinking agent is a polyfunctional compound having functional groups that react with the reactive functional group of monomer (a).

18. The method according to claim 17, wherein the acrylic-based copolymer comprises a carboxyl group and the crosslinking agent is an epoxy-based compound.

19. The method according to claim 15, wherein the solder reflow step occurs at a temperature of at least 260° C.
